(19) United States
(12) Patent Application Publication
(10) Pub. No.: US 2016/0237699 A1
(43) Pub. Date: Aug. 18, 2016

(54) ACCESS FLOOR-PANEL AND CORE

(71) Applicant: Vince Derrick, Halton Hills (CA)

(72) Inventor: Vince Derrick, Halton Hills (CA)

(21) Appl. No.: 15/046,149

(22) Filed: Feb. 17, 2016

Related U.S. Application Data
(60) Provisional application No. 62/117,033, filed on Feb. 17, 2015.

(51) Int. Cl. E04F 15/024; B32B 3/30; B32B 13/06; B32B 3/06; B32B 7/12; E04B 5/44; B32B 3/26

(52) U.S. Cl. CPC E04F 15/02429; E04B 5/44; B32B 3/30; B32B 3/266; B32B 3/06; B32B 7/12; B32B 13/06; B32B 2255/26; B32B 2307/72; B32B 2307/546; B32B 2307/536; B32B 2419/00

(57) ABSTRACT

A concrete core for a structural floor panel and a method for making the concrete core are disclosed. The concrete core may have substantially parallel and flat top and bottom surfaces that are separated by a desired thickness. At least one edge may be contiguous with the peripheries of the top and bottom surfaces. The concrete core may include a monolithic casting of material that has cement, coarse lightweight aggregate, water, fly ash and sand constituent ingredients. In various embodiments, the monolithic casting has a mass density in the range of 1650-1850 kilograms per cubic meter. A predetermined volume of reinforcing fibers may be added as a constituent ingredient during the casting process to give the concrete core additional strength characteristics. The reinforcing fibers may be steel, iron, polymer, made from other materials, or a combination thereof.

### TECHNICAL FIELD

The invention relates generally to flooring systems for buildings, and to access floors for enclosing under-floor air delivery plenums within buildings.

### BACKGROUND OF THE INVENTION

Under-floor air delivery plenums are an energy-efficient means of air distribution, popularly used in heating and cooling schemes for large spaces, particularly in office buildings. The system typically employs a raised access floor having a plurality of floor panels supported by a plurality of support posts above a structural floor in abutting end to end fashion. The space between the floor panels and the structural floor forms a plenum, through which conditioned (e.g. heated or cooled) air can be forced to circulate from a centrally located source. Apertures and vents in the floor panels permit the conditioned air to enter the room above the floor panels. Under-floor air delivery plenums are desirable because they permit widespread distribution of conditioned air throughout large spaces without extensive and complex ductwork.

The floor panels used in access floors must have sufficient bending strength, shear strength, and rigidity to support the loads of the room above (furniture, equipment, personnel, activities etc.). The floor panels must have sufficiently precise dimensions to permit forming an airtight seal between their abutting edges. The floor panels must be sufficiently light as to not impose undue structural loads on the support posts and structural floor. For widespread adoption, the access floor system must have sufficiently low cost of manufacture and installation to be commercially competitive with other air distribution systems.

Designers of access floors are typically faced with several problems. For example, lightweight strong materials are often too costly for particular applications, while inexpensive materials such as reinforced concrete are too heavy for particular applications. Furthermore, it is often necessary to install a carpet above the access floor in order to form a substantially airtight seal.

It would therefore be advantageous to provide a lightweight concrete access-floor panel that has desired strength and weight characteristics and a method of manufacture thereof that mitigates or eliminates at least one disadvantage of the prior art.

### SUMMARY

In accordance with one aspect of the invention, there is disclosed a structural floor panel for use in a raised access floor arrangement that forms an under-floor plenum air distribution plenum. The floor panel may include a lightweight concrete core bonded to a concave pan by means of an adhesive. The concrete core has substantially flat and parallel top and bottom surfaces that oppose each other. At least one edge may be positioned contiguous with the respective peripheries of the top and bottom surfaces. The concrete core includes a monolithic casting of constituent ingredients that may include cement, coarse lightweight aggregate, water, fly ash, and sand. The resulting casting (i.e. concrete core) may have a mass density in the range of 1650 to 1850 kilograms per cubic meter.

In an aspect, the concrete core may have a compressive strength in the range of 40 to 50 megapascals and/or a flexural strength in the range of 5 to 7 megapascals.

In another aspect, a volume of reinforcing fibers may be added during the casting process to provide additional properties to the concrete core. The reinforcing fibers may be made from steel, iron, carbon/graphite, a polymer, or a combination thereof, or from other materials.

In yet another aspect, the concrete core is adapted for use in the concrete access floor panel by having bevelled edges and a 120-150 Grit finish on the bonded surfaces.

In an aspect, the concrete core is manufactured by mixing its prepared ingredients in a dry-casting apparatus.

### DESCRIPTION OF THE DRAWINGS

In the drawings,

FIG. 1 depicts a general perspective view of the lower aspect of the concrete core of the invention, indicated generally by reference number 100, illustrating the general form thereof, according to an embodiment of the invention;

FIG. 2 depicts a partial cross-sectional profile view of the structural floor panel of the invention, indicated generally by reference number 200, illustrating the general configuration and the components thereof, according to an embodiment of the invention; and

FIG. 3 depicts a process (i.e. method of manufacture) for making a concrete structural floor panel, according to an embodiment of the invention.

### DESCRIPTION OF THE INVENTION

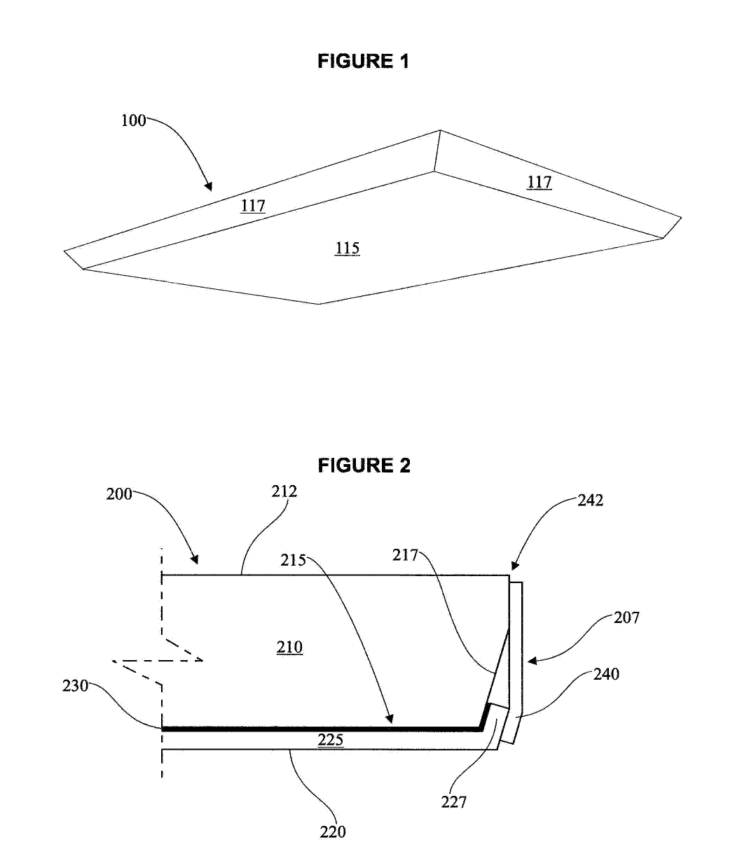

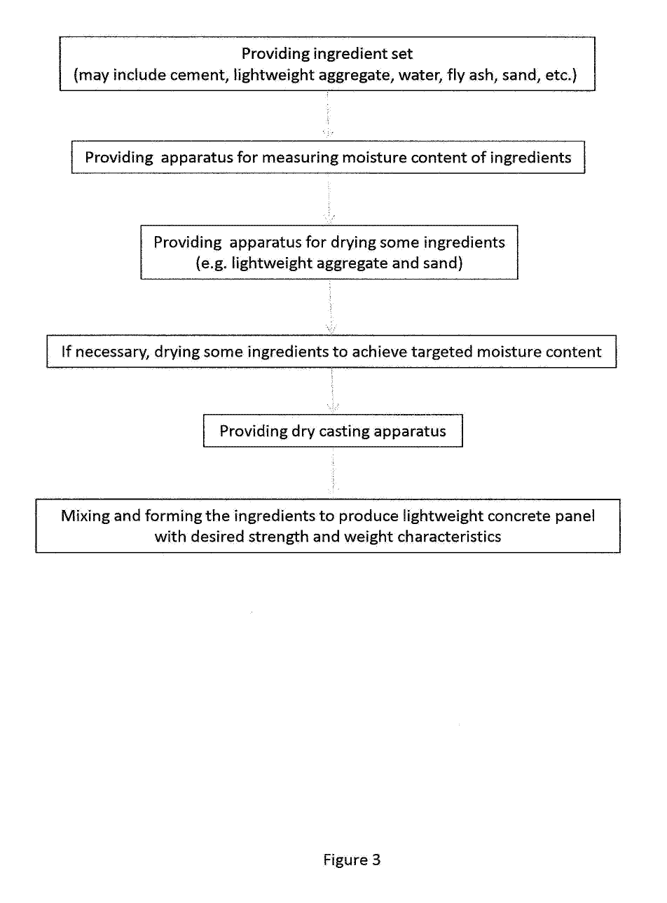

FIG. 1 illustrates an embodiment of a concrete core 100 for use in structural access floor panel. In a typical access floor system, a number of structural floor panels are placed in an adjacent arrangement to create an access floor with an air distribution plenum formed below the access floor.

The concrete core 100 may have a flat rectangular bottom surface 115 positioned substantially parallel to a flat top surface (not shown). The concrete core 100 may have a bevelled edge 117 that is positioned contiguous with the respective peripheries of the bottom surface 115 and the top surface. The concrete core 100 may be a monolithic casting of constituent ingredients selected from an ingredient set that may include cement, coarse lightweight aggregate, water, fly ash, and sand.

The proportion of the ingredients may vary depending on a particular application and the desired characteristics of the structural concrete core 100; however, in some embodiments the concrete core 100 comprises the following ingredients and respective proportions by mass, 18% ±1% cement, 45% ±1% coarse lightweight aggregate, 7% ±1% water, 6% ±1% fly ash, 24% ±1% sand.

In various embodiments, the structural concrete core 100 (210 in FIG. 2) has a mass density in the range of 1650-1850 kg/m3, a compressive strength of in the range of 40-50 MP, and a flexural strength in the range of 5-7 MP.

In some embodiments, reinforcing fibers may be added as an ingredient during the casting process to give the concrete core desired characteristics such as additional compressive and flexural strength. The reinforcing fibers may be oriented so as to provide specific strength characteristics.

The reinforcing fibers may be made from a variety of materials such as steel, iron, carbon/graphite, polymers, and/or particular combinations thereof.

Referring to FIG. 2, in an embodiment of the invention an access floor panel 200 includes a pan 220, a structural concrete core 210, a bond layer 230, and an adhesive sealant tape 240. The bottom panel 225 of the pan 220 may have a form substantially identical to the bottom surface 215 of the concrete core 210. The side 227 of the pan 220 may conform substantially to the edge 217 of the concrete core 210. A bond layer 230, of an adhesive filler material, spans and substantially fills the interface between the pan 220 and the concrete core 210.

A sealant tape 240 may be affixed to the edge 217 of the concrete core 210 near the perimeter 242 of the top surface 212 of the concrete core 210, and encircles the periphery of the structural panel 200. In some embodiments, a fluid sealant such as calking may be applied in the place of sealant tape.

In some embodiments, the concrete core 100, 210 has a 5° bevelled edge 117, 217 to facilitate assembly with the pan 220. The bevelled edge may vary from 5° in certain applications. In another aspect, the concrete core 100, 210 has a surface finish of 120-150 Grit on its bottom surface 115, 215 and edge 117, 217, to facilitate adhesion of the filler layer.

In another aspect, an adhesive sealant tape encircles the edge of the panel 200 to seal the structural gap between the panel 200 and adjacent panel(s).

In some embodiments, the core 210 is casted in a predetermined manner to be thinner than the desired thickness of the panel (by more than the thickness of the pan) so that a face surface may be applied to the top surface of the core. By applying the face surface, the desired thickness of the panel is achieved. A particular face surface may be applied for one or more aesthetic and/or functional reasons, such as slip/wear resistance, weight/cost, or to create a pattern or effect desired by the user.

In another aspect, the panel 200 has a square shape and a thickness of approximately 25.4 mm. It will be appreciated that the surface shape and thickness of a panel (or core) of the invention may vary according to a particular application. For example, a panel may have a surface shape that is triangular, rectangular, polygonal, etc.

In another aspect, a hole proximate to each corner of the panel permits mounting and alignment of the panel as part of an access floor. The holes may be aligned with support posts that support the access floor. The holes typically penetrate the panel (through the core and pan) such that a securing device such as a bolt or pin can securely join the panel to the support posts. In some embodiments, a plurality of structural panels 200 may be placed in adjacent fashion and secured to a plurality of support posts to create an under-floor air delivery plenum. A variety of panels 200 may be chosen based on their respective face surface to create a desired floor pattern or aesthetic appearance. The panels may be selected from a variety of surface shapes as described above (such as square, rectangular, polygonal, etc.) to provide a desired look and effect for a particular floor application.

In some embodiments, each panel may be supported by one or more support posts with each support post having a pedestal head at its top for supporting the load of one or more panels. The pedestal head may include a self-leveling acoustic gasket. The gasket operates to restrict sound from travelling between the respective panels and other parts of the floor assembly to adjacent rooms and areas, as well as to restrict air from leaking from the plenum below the panels.

In some embodiments, one or more stringers (i.e. rails) may be connected between various support posts. A panel may sit on the stringers in addition to the pedestal heads. The stringers may include a gasket to facilitate self-leveling of the panels, and to restrict acoustic communication and air leakage from the plenum. The stringer gaskets and pedestal head gaskets may be formed from felt, foam and/or other suitable materials.

In some embodiments, a given pedestal head is adapted to support a plurality of panels. Typically, four panels are supported by a single pedestal head (when the panels are in the middle of the floor and not adjacent to the perimeter of the building). A given pedestal head may include four locating tabs which protrude upwards from the pedestal head. The locating tabs facilitate the locating/guiding of each panel on the pedestal head during installation and also operate to keep each panel in place during use. When each of the four panels is located on the pedestal head, a panel/head connection may be installed at the interface of all four panels with a single hold down location fastener and tension washer. The hold down location fastener may be a bolt. When the tension washer is installed, it places a downwards force on each panel thus securing each panel and adding additional strength and stability to each panel. It will be appreciated that panels in the middle area of the floor will be installed with four tension washers, one each at the interface of each corner of the panels with the adjacent panels.

In some embodiments, a calibration process may be implemented to ensure that the metal pan is formed with precision during formation (i.e. stamping and forming) and after the pan is formed together with the concrete core. An edge coating may be painted on each side of the panel (i.e. on the pan) which operates to restrict air leakage and acoustic communication between adjacent panels and other parts of the floor system. The edge coating operates as a gasket integrated into the panel. In some embodiments, the concrete core is not integrated with a metal pan and an edge coating is applied direction to the concrete surface. The coating (whether applied to the pan or directly to the concrete core) also provides structural edge protection during installation and while in use.

The resulting panel may be constructed with specific characteristics within known tolerances. In one embodiment, the panel has a precise size with a tolerance of maximum +/−0.010″ which allows low bare panel air leakage value and precise ability for each panel to stay on a 24.000″ grid layout throughout the flooring system. The concrete core may have a relatively high internal particle bond which reduces pull out of concrete particles and performs well in dynamic and static loading situations. The concrete core may be ground with diamond abrasion under water to a fine approximation of 100 grit roughness.

In some embodiments, a panel is made by adhering a steel pan to the concrete core with a reactive (moisture cure) polyurethane adhesive. The adhesive may be applied at a rate of 10 grams/sf. Given that the grinding in one embodiment is performed under water, the unique composition and process of creating the concrete core allows an amount of water to be retained within the concrete core. The combination of the reactive moisture cure adhesive facilitates curing (bond strength) between the pan and the core and within the core itself for a period of time after the adhesive is applied. This essentially allows the internal bond of the concrete core itself and between the core and the pan to strengthen over time.

In some embodiments, the resulting panel assembly has superior acoustic value due to its higher density and low air leakage value which affects flanking acoustic sound.

In some embodiments, the concrete core is ground to precise dimensional tolerance of maximum +/−0.010″ on thickness and flat and parallel with +/−0.015″.

In some embodiments, the panel assembly is 0.875″ thick +/−0.010″ and has structural capacity on 24″ centers sufficient to meet all structural building codes in North America. The panel assembly may be non-combustible according to building code definitions CAN/ULC 5135 in Canada ASTM E 136 in the United States.

In some embodiments, a process for manufacturing (i.e. a method of manufacture for) a concrete core (such as cores 100, 210) includes providing a constituent ingredient set to give the resulting core particular strength, weight, tolerance, and other desired characteristics. The ingredient set may include a variety of materials in predetermined proportions such as 18% ±1% cement by mass, 45% ±1% coarse lightweight aggregate by mass, 7% ±1% water by mass, 6% ±1% fly ash by mass and 24% ±1% sand by mass. An apparatus for measuring the moisture content of some or all the ingredients (such as a moisture meter) may be provided. In some embodiments, an apparatus for drying some of all of the ingredients may also be provided. In other embodiments, certain ingredients may be dried in the environment using evaporation.

To mix the ingredients, a concrete dry-casting apparatus (such as a mixer and/or consolidation equipment) is provided as well as a mold (i.e. form) for forming the concrete core.

The lightweight aggregate and/or sand may be dried using the drying apparatus to a predetermined moisture value. The desired moisture value may be determined in advance according to a particular access-flooring application to give the resulting concrete core desired characteristics. In some embodiments, the proportion of ingredients may be adjusted depending on the measured moisture content and the desired moisture content. For example, it may be found that the sand has a higher moisture content than is desired. The relative proportion of sand relative to lightweight aggregate may be adjusted (in this example, by providing more lightweight aggregate) so that the desired moisture content may be achieved. In other embodiments, constituent ingredients may be dried as described above using the drying apparatus (such as a fan or by applying heat) and/or relying on evaporation.

The process of manufacture includes mixing and forming the ingredients using a dry-casting apparatus and forming the mixed materials into a monolithic concrete casting by employing a mold.

The resulting concrete cast formed may have a mass density selected from the range 1650-1850 kilograms per cubic meter, a compressive strength selected from the range 40-50 megapascals, and/or a flexural strength selected from the range 5-7 megapascals.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

What is claimed is:

1. A concrete core for use in a structural floor panel, the concrete core comprising:
substantially parallel, substantially flat, opposite top and bottom surfaces separated by a predefined thickness;
at least one edge, said at least one edge contiguous with the respective peripheries of said top and bottom surfaces;
a monolithic casting of a concrete material comprising cement, coarse lightweight aggregate, water, fly ash, and sand;
said concrete material having a mass density in the range of 1650-1850 kilograms per cubic meter.

2. The concrete core of claim 1, wherein the cement comprises 18%±1% of the core mass.

3. The concrete core of claim 2, wherein the coarse lightweight aggregate comprises 45%±1% of the core mass.

4. The concrete core of claim 3, wherein the water comprises 7%±1% of the core mass.

5. The concrete core of claim 4, wherein the fly ash comprises 6%±1% of the core mass.

6. The concrete core of claim 5, wherein the sand comprises 24%±1% of the core mass.

7. The concrete core of claim 6, the monolithic casting having a compressive strength in the range of 40-50 megapascals.

8. The concrete core of claim 7, the monolithic casting having a flexural strength in the range of 5-7 megapascals.

9. The concrete core of claim 8, further comprising reinforcing fibers.

10. The concrete core of claim 9, wherein the material, concentration, and orientation of the reinforcing fibers are selected to provide particular strength characteristics.

11. The concrete core of claim 10, wherein:
the at least one edge forms an acute angle with the top surface, and an obtuse angle with the bottom surface;
the bottom surface, and the at least one edge, have a surface finish substantially equal to a finish produced by grinding to a predefined Grit value.

12. A structural panel for use in an access floor, the structural panel comprising:
A concrete core for use in a structural floor panel, the concrete core comprising:
substantially parallel, substantially flat, opposite top and bottom surfaces separated by a predefined thickness;
at least one edge, said at least one edge contiguous with the respective peripheries of said top and bottom surfaces;
a monolithic casting of a concrete material comprising cement, coarse lightweight aggregate, water, fly ash, and sand;
said concrete material having a mass density in the range of 1650-1850 kilograms per cubic meter;
a pan comprising a bottom panel, said bottom panel having a profile substantially identical to the bottom surface of the concrete core; said pan located proximate to and oriented substantially parallel to the bottom surface of the concrete core, separated therefrom by a gap;
a bond layer comprising an adhesive filler material, said bond layer adhering to the concrete core, said bond layer adhering to the metal pan; said bond layer spanning and substantially filling the gap between the metal pan and the concrete core.

13. The structural panel of claim 12, the pan further comprising:
at least one side, said at least one side contiguous with the periphery of the bottom panel,
said at least one side oriented substantially parallel to, and located proximate to, the at least one edge of the concrete core, separated therefrom by a gap;
the bond layer spanning and substantially filling the gap between the at least one side of the pan and the at least one edge of the concrete core.

14. The structural panel of claim 13, further comprising a sealant tape.
said sealant tape affixed to the at least one edge of the concrete core, said sealant tape located proximate to, and oriented parallel to, the perimeter of the top surface of the concrete core.

15. The structural panel of claim 14, wherein:
the opposite top and bottom surfaces of the concrete core, and the bottom panel of the pan, have a substantially square shape;
the thickness of the concrete core approximately equals approximately 25.4 millimeters;
the acute angle formed by the at least one edge and the top surface approximately equals approximately 85 degrees;
the surface finish of the bottom surface and the at least one edge of the concrete core substantially equals a finish produced by grinding to a Grit value selected from the range 120-150 Grit;
the pan comprises a material selected to provide particular characteristics of strength and rigidity.

16. The structural panel of claim 15, further comprising at least one mounting hole,
said at least one mounting hole aligned substantially perpendicular to the opposite top and bottom surfaces,
said at least one mounting hole located proximate to each corner of the opposite top and bottom surfaces

17. The structural panel of claim 16, adapted for use as an access floor panel for use in a raised access floor, said raised access floor forming part of an air distribution system.

18. The structural panel of claim 17, further comprising at least one mounting hole penetrating through the structural panel and concrete core, the mounting hole adapted to align with at least one support post and to receive at least one securing device such as a bolt.

19. A process for making a concrete core for use in a structural panel, the process including the steps of,
providing an ingredient set comprising:
18%±1% cement by mass,
45%±1% coarse lightweight aggregate by mass,
7%±1% water by mass,
6%±1% fly ash by mass,
24%±1% sand by mass;
providing an apparatus for measuring the moisture content of coarse lightweight aggregate and sand;
providing an apparatus for drying coarse lightweight aggregate and sand;
providing a concrete dry-casting apparatus comprising mixing apparatus and a mold;
drying said lightweight aggregate and said sand to a predetermined moisture value;
Mixing and forming the ingredients for using the concrete dry-casting apparatus, forming thereby a monolithic casting of a reinforced cementitic concrete material;
in which the reinforced cementitic concrete material formed thereby having a mass density selected from the range 1650-1850 kilograms per cubic meter, a compressive strength selected from the range 40-50 megapascals, and a flexural strength selected from the range 5-7 megapascals.

20. The process of claim 19, further including the step of providing a volume of reinforcing fibers to the ingredient set.
